(19) United States
(12) Patent Application Publication
(10) Pub. No.: US 2021/0006329 A1
(43) Pub. Date: Jan. 7, 2021

(54) REFERENCE STATION HANDOVER

(71) Applicant: WAYSURE SWEDEN AB, Stockholm (SE)

(72) Inventors: James TIDD, Stockholm (SE); Jakob ALMQVIST, Stockholm (SE); Isak TJERNBERG, Stockholm (SE)

(21) Appl. No.: 16/758,689

(22) PCT Filed: Oct. 19, 2018
(86) PCT No.: PCT/EP2018/078787

§ 371 Date: Apr. 23, 2020

(30) Foreign Application Priority Data
Oct. 24, 2017 (GB) 1717490.5

(51) Int. Cl. H04B 7/185; G01S 19/44; H04W 36/32; H04W 64/00

(52) U.S. Cl. CPC H04B 7/18547; G01S 19/44; H04W 64/006; H04W 36/32; H04B 7/18539

(57) ABSTRACT

A method for calculating a position of a mobile device relative to a selected reference station of a plurality of reference stations, the method comprising: receiving satellite signal measurements associated with a first reference station; receiving location signals from a plurality of satellites; tracking a baseline between the mobile device and the first reference station using the satellite signal measurements associated with the first reference station and the location signals to provide the position of the mobile device relative to the first reference station; sending a handover request, the handover request comprising the current position of the mobile device; receiving a handover message comprising integer ambiguities for a baseline between the first reference station and the second reference station; initialising tracking of a baseline between the mobile device and the second reference station using the integer ambiguities of the handover message; receiving satellite signal measurements associated with the second reference station; and tracking the baseline between the mobile device and the second reference station using the satellite signal measurements associated with the second reference station and the location signals to provide the position of the mobile device relative to the second reference station.

This invention relates to methods and devices for calculating a position of a mobile device relative to a selected reference station of a plurality of reference stations.

It is becoming increasingly common for mobile devices to have the ability to calculate their absolute position using various Global Navigation Satellite Systems (GNSS) such as GPS, GLONASS, Galileo and BeiDou. These systems can be used to calculate a rough position of the mobile device by the mobile device receiving location signals from a plurality of satellites that are part of one or more GNSS. This calculation usually makes use of these location signals to calculate pseudoranges between a receiver in the mobile device and each of the satellites associated with the location signals that are being received together with the estimated location of the satellites. These pseudoranges can then be used to solve positioning equations to determine a rough position for the mobile device. The location signal may comprise a pseudo random noise (PRN) code that has modulated a carrier signal. The calculations of the rough position of the mobile device can use the PRN code to determine the pseudoranges to each of the satellites. The rough positions using these methods can usually be calculated to within 5 to 20 meters. Such a resolution is acceptable in many situations, for instance in satellite navigation systems in smartphones or in vehicles where the satellite navigation system is used to display routing information from the current location. In these situations, the navigation of the person or vehicle itself is done using other means, for instance by the person looking around or by a user piloting the vehicle.

There are an increasing number of situations where a more accurate position using the various GNSS is desirable. For example, a very accurate position could be useful for self-driving vehicles. Such an accurate position can be generated using the carrier phases and/or code phases of the location signals transmitted by the plurality of satellites that are measured at two separate receivers. Generally, one of the receivers has a fixed position that has been accurately surveyed so that it can act as a reference point in positioning calculations. The other receiver can be mobile. The two sets of received satellite location signals can be processed together to calculate a baseline between the two receivers with cm or mm level accuracy. The baseline being the vector between the positions of the two receivers. If the position of the fixed receiver is accurately surveyed then the actual position of the mobile receiver can also be calculated with high accuracy.

The mobile receiver can receive satellite location signals directly and can also receive signal measurements of the satellite location signals as received by the fixed receiver. These measurements can be differenced to form double difference observables. In the case of carrier phase measurements, a double difference observable is the difference in the carrier phase of a specific satellite location signal at both receivers compared to the difference in the carrier phase of another satellite location signal at both receivers. The double difference technique is useful because there are certain errors that are present in the satellite signal that can be removed using this technique. This is because it can be assumed that those errors are the same whether they are received by the fixed receiver or the mobile receiver in part due to the propagation path being similar.

The carrier signal of the location signal usually has a relatively high frequency. For instance, the L1 carrier signal in the GPS system has a frequency of 1575.42 MHz. This assists in the accurate positioning technique described above, but also does not contain information that can be used to calculate the number of wavelengths between the satellite and the receiver. This is problematic when using the double difference technique because there is an uncertainty in the difference between the number whole cycles of the carrier signal as received at the fixed receiver relative to the mobile receiver. This is generally referred to as the double difference integer ambiguity between those two receivers for the satellite pair. The satellite pair being a reference satellite-other satellite pair who's carrier signals are differenced to give one difference of the double differenced signal. This ambiguity can be resolved by gathering location signals from enough satellites and then solving the positioning equations using an iterative approach to give the value for the integer ambiguities. Such a process is generally referred to as the integer ambiguity initialization process. This initialization process takes time to complete during which time the high accuracy location cannot be determined. As the number of carrier wave cycles can alter depending on the fixed receiver that is being used by the mobile receiver, the initialization process needs to be completed when there is a switch in fixed receiver during which time the accurate position cannot be determined. Movement from one fixed receiver to another is desirable as the length of the baseline between the mobile receiver and the fixed receiver grows because the assumption that the errors received by both receivers are the same and so cancel breaks down as the distance between the receivers increases. The main error source is due to the signals travelling through different parts of the atmosphere which cause dissimilar effects on the location signal.

One such technique that undertakes such calculations on measurement streams from reference stations to calculate baselines between the reference station and a mobile device is the Real-Time Kinematic (RTK) satellite navigation. It will be appreciated that the calculation techniques of RTK satellite navigation and other approaches of calculating baselines using differenced measurement streams are well known in the art and so readily applied to the techniques disclosed herein

The fixed receiver may be known as a reference station. Additionally, the fixed receiver may be a physical reference station that actually receives location signals from satellites. Alternatively, the fixed receiver may be a virtual reference station. In this case, the location signal measurements are generated based on the measurements made by the physical reference stations that are physically located in different positions to where the virtual reference station is calculated to be.

US2010/0090890 proposes a solution to the problem with reinitialization when changing reference station by configuring the mobile device so that it can receive the measurement signals associated with two reference stations at once. The mobile device changes measurement signals from one reference station that were being used prior to the handover to using the measurement signals from the new reference station. The reception of both signals allows the mobile device to calculate the integer ambiguities for the new reference station before the mobile device stops calculating its position based on the measurement signals from the first reference station. This allows for no loss of position during the handover. The disadvantages to this technique are that the mobile device needs to be capable of receiving measurement signals from two reference stations at once, and have the processing capability to process both sets of measurement signals in parallel whilst the calculation using the second reference station is initializing. The system also assumes that virtual reference stations will be generated for each mobile station at locations close to the mobile station when the handover occurs. This means that the processing requirements increase as more mobile stations use the system. The technical descriptions of US2010/0090890 is incorporated by reference where permitted by law although the present application should be interpreted without reference to this document.

It is therefore desirable for there to be improved methods and devices for switching reference stations.

According to a first aspect of the present invention there is provided a method for calculating a position of a mobile device relative to a selected reference station of a plurality of reference stations, the method comprising: receiving satellite signal measurements associated with a first reference station; receiving location signals from a plurality of satellites; tracking a baseline between the mobile device and the first reference station using the satellite signal measurements associated with the first reference station and the location signals to provide the position of the mobile device relative to the first reference station; sending a handover request, the handover request comprising the current position of the mobile device; receiving a handover message comprising integer ambiguities for a baseline between the first reference station and the second reference station; initialising tracking of a baseline between the mobile device and the second reference station using the integer ambiguities of the handover message; receiving satellite signal measurements associated with the second reference station; and tracking the baseline between the mobile device and the second reference station using the satellite signal measurements associated with the second reference station and the location signals to provide the position of the mobile device relative to the second reference station.

Sending a handover request may comprise sending a handover request when the baseline between the mobile device and the first reference station is at least equal to a maximum baseline length. Sending a handover request may comprise sending a handover request in response to at least one handover condition being fulfilled. The at least one handover condition may comprise the baseline between the mobile device and the first reference station being at least equal to a maximum baseline length. The at least one handover condition may comprise a predetermined length of time has elapsed since a handover request was sent. The at least one handover condition may comprise the tracking of the baseline between the mobile device and current reference station exhibiting outliers in the calculated position of the mobile device. The at least one handover condition may comprise the tracking of the baseline between the mobile device and the current reference station causes the calculated position of the mobile device to fall below a predetermined quality level.

The method may comprise calculating integer ambiguities for the baseline between the mobile device and the first reference station using the satellite signal measurements associated with the first reference station and the location signals. The satellite signal measurements may comprise carrier-phase measurements of satellite signals. The first reference station and second reference station may be virtual reference stations. The handover request may comprise an identifier for the first reference station. The handover message may comprise a handover vector that comprises the integer ambiguities for the baseline between the first reference station and the second reference station. The integer ambiguities may be double difference integer ambiguities. The double difference integer ambiguities may be calculated between the signals of a reference satellite and other satellites as received at two reference stations. The two reference stations may be the first and second reference stations. Initialising tracking of a baseline between the mobile device and the second reference station may comprise transforming the integer ambiguities for the baseline between the mobile device and the first reference station into integer ambiguities for the baseline between the mobile device and the second reference station using the integer ambiguities of the handover message. Receiving satellite signal measurements associated with the second reference station may comprise receiving satellite signal measurements associated with the second reference station whilst not receiving satellite signal measurements associated with the first reference station. The integer ambiguities of the handover message may be a set of integer ambiguities for the double differenced satellite signal measurements associated with the first and second reference stations. The method may comprise sending, prior to receiving satellite signal measurements associated with the first reference station, a measurement stream request comprising the current position of the mobile device. The satellite signal measurements may be computed satellite signal measurements based on measurements by a plurality of physical reference stations.

According to a second aspect of the present invention there is provided a method for providing satellite signal measurements to enable calculation of a position of a mobile device relative to a selected reference station of a plurality of reference stations, the method comprising: transmitting satellite signal measurements associated with a first reference station to a mobile device; receiving a handover request comprising a current position of the mobile device; selecting a second reference station based on the current position of the mobile device; calculating integer ambiguities for a baseline between the first reference station and the second reference station using satellite signal measurements associated with the first reference station and satellite signal measurements associated with the second reference station; transmitting a handover message comprising the integer ambiguities for the baseline between the first reference station and the second reference station; and transmitting satellite signal measurements associated with the second reference station to the mobile device.

Selecting a second reference station may comprise selecting the reference station that has a position closest to the current position of the mobile device. The handover message may comprise a handover vector that comprises the integer ambiguities for the baseline between the first reference station and the second reference station. The method may comprise calculating the satellite signal measurements associated with the first reference station based on satellite signal measurements received by a plurality of physical reference stations. The method may comprise calculating the satellite signal measurements associated with the second reference station based on satellite signal measurements received by a plurality of physical reference stations. The satellite signal measurements may comprise carrier-phase measurements of satellite signals. The first reference station and second reference station may be virtual reference stations. Transmitting satellite signal measurements associated with the second reference station to the mobile device may comprise transmitting satellite signal measurements associated with the second reference station to the mobile device whilst not transmitting satellite signal measurements associated with the first reference station to the mobile device. Calculating integer ambiguities for a baseline between the first reference station and the second reference station may comprise calculating a set of integer ambiguities for the double differenced satellite signal measurements associated with the first and second reference stations.

According to a third aspect of the present invention there is provided a mobile device for calculating a position of the mobile device relative to a selected reference station of a plurality of reference stations, the mobile device comprising: a satellite receiver configured to receive location signals from a plurality of satellites; and a communications interface configured to receive satellite signal measurements associated with a selected one of the plurality of reference stations; wherein the mobile device is configured to: receive satellite signal measurements, using the communications interface, associated with a first reference station; receive location signals, using the satellite receiver, from a plurality of satellites; track a baseline between the mobile device and the first reference station using the satellite signal measurements associated with the first reference station and the location signals to provide the position of the mobile device relative to the first reference station; send a handover request, the handover request comprising the current position of the mobile device; receive a handover message comprising integer ambiguities for a baseline between the first reference station and the second reference station; initialise tracking of a baseline between the mobile device and the second reference station using the integer ambiguities of the handover message; receive satellite signal measurements, using the communication interface, associated with the second reference station; and track the baseline between the mobile device and the second reference station using the satellite signal measurements associated with the second reference station and the location signals to provide the position of the mobile device relative to the second reference station.

The device may be configured to send a handover request by sending a handover request when the baseline between the mobile device and the first reference station is at least equal to a maximum baseline length. The device may be configured to send a handover request by sending a handover request in response to at least one handover condition being fulfilled. The at least one handover condition may comprise the baseline between the mobile device and the first reference station being at least equal to a maximum baseline length. The at least one handover condition may comprise a predetermined length of time has elapsed since a handover request was sent. The at least one handover condition may comprise the tracking of the baseline between the mobile device and current reference station exhibiting outliers in the calculated position of the mobile device. The at least one handover condition may comprise the tracking of the baseline between the mobile device and the current reference station causes the calculated position of the mobile device to fall below a predetermined quality level.

The device may be configured to: calculate integer ambiguities for the baseline between the mobile device and the first reference station using the satellite signal measurements associated with the first reference station and the location signals. The satellite signal measurements may comprise carrier-phase measurements of satellite signals. The first reference station and second reference station may be virtual reference stations. The handover request may comprise an identifier for the first reference station. The handover message may comprise a handover vector that comprises the integer ambiguities for the baseline between the first reference station and the second reference station. The device may be configured to initialise tracking of a baseline between the mobile device and the second reference station by transforming the integer ambiguities for the baseline between the mobile device and the first reference station into integer ambiguities for the baseline between the mobile device and the second reference station using the integer ambiguities of the handover message. The device may be configured to receive satellite signal measurements associated with the second reference station by receiving satellite signal measurements associated with the second reference station whilst not receiving satellite signal measurements associated with the first reference station. The integer ambiguities of the handover message may be a set of integer ambiguities for the double differenced satellite signal measurements associated with the first and second reference stations. The device may be configured to send, prior to receiving satellite signal measurements associated with the first reference station, a measurement stream request comprising the current position of the mobile device. The satellite signal measurements may be computed satellite signal measurements based on measurements by a plurality of physical reference stations.

According to a fourth aspect of the present invention there is provided a positioning server device for providing satellite signal measurements to enable calculation of a position of a mobile device relative to a selected reference station of a plurality of reference stations, the device comprising at least one communication interface, the device being configured to communicate with a plurality of physical reference stations using at least one of the communication interfaces and communicate with the mobile device using at least one of the communication interfaces; the device being configured to: transmit satellite signal measurements associated with a first reference station to a mobile device; receive a handover request comprising a current position of the mobile device; select a second reference station based on the current position of the mobile device; calculate integer ambiguities for a baseline between the first reference station and the second reference station using satellite signal measurements associated with the first reference station and satellite signal measurements associated with the second reference station; transmit a handover message comprising the integer ambiguities for the baseline between the first reference station and the second reference station; and transmit satellite signal measurements associated with the second reference station to the mobile device.

The device may be configured to select a second reference station by selecting the reference station that has a position closest to the current position of the mobile device. The handover message may comprise a handover vector that comprises the integer ambiguities for the baseline between the first reference station and the second reference station. The device may be configured to calculate the satellite signal measurements associated with the first reference station based on satellite signal measurements received by a plurality of physical reference stations. The device may be configured to calculate the satellite signal measurements associated with the second reference station based on satellite signal measurements received by a plurality of physical reference stations. The satellite signal measurements may comprise carrier-phase measurements of satellite signals. The first reference station and second reference station may be virtual reference stations. The device may be configured to transmit satellite signal measurements associated with the second reference station to the mobile device by transmitting satellite signal measurements associated with the second reference station to the mobile device whilst not transmitting satellite signal measurements associated with the first reference station to the mobile device. The device may be configured to calculate integer ambiguities for a baseline between the first reference station and the second reference station by calculating a set of integer ambiguities for the double differenced satellite signal measurements associated with the first and second reference stations.

According to a fifth aspect of the present invention there is provided a method for providing satellite signal measurements to enable calculation of a position of a mobile device relative to a selected reference station of a plurality of reference stations, the method comprising: transmitting satellite signal measurements associated with a first reference station to a mobile device; receiving a receiving a handover request comprising a current position of the mobile device; selecting a second reference station based on the current position of the mobile device; calculating integer ambiguities for a baseline between a first reference station and the second reference station using satellite signal measurements associated with the first reference station and satellite signal measurements associated with the second reference station; adjusting satellite signal measurements associated with the second reference station so that the integer ambiguities for the baseline between the first reference station and the second reference station are equal to predetermined integer ambiguities; and transmitting the adjusted satellite signal measurements associated with the second reference station to the mobile device.

Adjusting satellite signal measurements associated with the second reference station may comprise adjusting satellite signal measurements associated with the second reference station so that the integer ambiguities for the baseline between the first reference station and the second reference station are equal to zero. The predetermined integer ambiguities may be equal to zero. Adjusting satellite signal measurements associated with the second reference station may comprise adjusting the satellite signal measurements associated with the second reference station using the calculated integer ambiguities for the baseline between the first reference station and the second reference station. Adjusting satellite signal measurements associated with the second reference station may comprise adjusting the satellite signal measurements associated with the second reference station by subtracting respective calculated integer ambiguities for the baseline between the first reference station and the second reference station from the satellite signal measurements associated with the respective integer ambiguities. The method may comprise transmitting a handover message indicating that the integer ambiguities are predetermined integer ambiguities. The method may comprise transmitting a handover message indicating an identifier for the second reference station. The method may comprise: receiving a subscribe message, the subscribe message requesting transmission of satellite signal measurements; and transmitting a subscribe response message, the subscribe response message indicating that integer ambiguities for the satellite signal measurements are predetermined integer ambiguities. Selecting a second reference station may comprise selecting the reference station that has a position closest to the current position of the mobile device. The method may comprise calculating the satellite signal measurements associated with the first reference station based on satellite signal measurements received by a plurality of physical reference stations. The method may comprise calculating the satellite signal measurements associated with the second reference station based on satellite signal measurements received by a plurality of physical reference stations. The satellite signal measurements may comprise carrier-phase measurements of satellite signals. The first reference station and second reference station may be virtual reference stations. Transmitting satellite signal measurements associated with the second reference station to the mobile device may comprise transmitting satellite signal measurements associated with the second reference station to the mobile device whilst not transmitting satellite signal measurements associated with the first reference station to the mobile device.

Calculating integer ambiguities for a baseline between the first reference station and the second reference station may comprise calculating a set of integer ambiguities for the double differenced satellite signal measurements associated with the first and second reference stations. Adjusting satellite signal measurements associated with the second reference station may comprise adjusting the set of integer ambiguities for the double differenced satellite signal measurements associated with the first and second reference stations.

According to a sixth aspect of the present invention there is provided a method for calculating a position of a mobile device relative to a selected reference station of a plurality of reference station, the method comprising: receiving satellite signal measurements associated with a first reference station; receiving location signals from a plurality of satellites; tracking a baseline between the mobile device and the first reference station using the satellite signal measurements associated with the first reference station and the location signals to provide the position of the mobile device relative to the first reference station; sending a handover request, the handover request comprising the current position of the mobile device; initialising tracking of a baseline between the mobile device and the second reference station using predetermined integer ambiguities; receiving satellite signal measurements associated with the second reference station; and tracking the baseline between the mobile device and the second reference station using the satellite signal measurements associated with the second reference station and the location signals to provide the position of the mobile device relative to the second reference station.

The method may comprise: sending a subscribe message, the subscribe message requesting transmission of satellite signal measurements; receiving a subscribe response message, the subscribe response message indicating that integer ambiguities for the satellite signal measurements are predetermined integer ambiguities. The predetermined integer ambiguities may be equal to zero. The method may comprise: receiving a handover message indicating that the integer ambiguities are predetermined integer ambiguities. The method may comprise: receiving a handover message indicating an identifier for the second reference station. Sending a handover request may comprise sending a handover request when the baseline between the mobile device and the first reference station is at least equal to a maximum baseline length.

Sending a handover request may comprise sending a handover request in response to at least one handover condition being fulfilled. The at least one handover condition may comprise the baseline between the mobile device and the first reference station being at least equal to a maximum baseline length. The at least one handover condition may comprise a predetermined length of time has elapsed since a handover request was sent. The at least one handover condition may comprise the tracking of the baseline between the mobile device and current reference station exhibiting outliers in the calculated position of the mobile device. The at least one handover condition may comprise the tracking of the baseline between the mobile device and the current reference station causes the calculated position of the mobile device to fall below a predetermined quality level.

The method may comprise calculating integer ambiguities for the baseline between the mobile device and the first reference station using the satellite signal measurements associated with the first reference station and the location signals. The satellite signal measurements may comprise carrier-phase measurements of satellite signals. The first reference station and second reference station may be virtual reference stations. The handover request may comprise an identifier for the first reference station. Initialising tracking of a baseline between the mobile device and the second reference station may comprise transforming the integer ambiguities for the baseline between the mobile device and the first reference station into integer ambiguities for the baseline between the mobile device and the second reference station using the predetermined integer ambiguities. Receiving satellite signal measurements associated with the second reference station may comprise receiving satellite signal measurements associated with the second reference station whilst not receiving satellite signal measurements associated with the first reference station. The predetermined integer ambiguities may be a set of integer ambiguities for the double differenced satellite signal measurements associated with the first and second reference stations. The method may comprise sending, prior to receiving satellite signal measurements associated with the first reference station, a measurement stream request comprising the current position of the mobile device. The satellite signal measurements may be computed satellite signal measurements based on measurements by a plurality of physical reference stations.

According to a seventh aspect of the present invention there is provided a positioning server device for providing satellite signal measurements to enable calculation of a position of a mobile device relative to a selected reference station of a plurality of reference stations, the device comprising at least one communication interface, the device being configured to communicate with a plurality of physical reference stations using at least one of the communication interfaces and communicate with the mobile device using at least one of the communication interfaces; the device being configured to: transmit satellite signal measurements associated with a first reference station to a mobile device; receive a receiving a handover request comprising a current position of the mobile device; select a second reference station based on the current position of the mobile device; calculate integer ambiguities for a baseline between the first reference station and the second reference station using satellite signal measurements associated with the first reference station and satellite signal measurements associated with the second reference station; adjust satellite signal measurements associated with the second reference station so that the integer ambiguities for the baseline between the first reference station and the second reference station are equal to predetermined integer ambiguities; and transmit the adjusted satellite signal measurements associated with the second reference station to the mobile device.

The device may be configured to adjust satellite signal measurements associated with the second reference station by adjusting satellite signal measurements associated with the second reference station so that the integer ambiguities for the baseline between the first reference station and the second reference station are equal to zero. The predetermined integer ambiguities may be equal to zero. The device may be configured to adjust satellite signal measurements associated with the second reference station by adjusting the satellite signal measurements associated with the second reference station using the calculated integer ambiguities for the baseline between the first reference station and the second reference station. The device may be configured to adjust satellite signal measurements associated with the second reference station by adjusting the satellite signal measurements associated with the second reference station by subtracting respective calculated integer ambiguities for the baseline between the first reference station and the second reference station from the satellite signal measurements associated with the respective integer ambiguities. The device may be configured to transmit a handover message indicating that the integer ambiguities are predetermined integer ambiguities. The device may be configured to transmit a handover message indicating an identifier for the second reference station. The device may be configured to: receive a subscribe message, the subscribe message requesting transmission of satellite signal measurements; and transmit a subscribe response message, the subscribe response message indicating that integer ambiguities for the satellite signal measurements are predetermined integer ambiguities. The device may be configured to selecting a second reference station by selecting the reference station that has a position closest to the current position of the mobile device. The device may be configured to calculate the satellite signal measurements associated with the first reference station based on satellite signal measurements received by a plurality of physical reference stations. The device may be configured to calculate the satellite signal measurements associated with the second reference station based on satellite signal measurements received by a plurality of physical reference stations. The satellite signal measurements may comprise carrier-phase measurements of satellite signals. The first reference station and second reference station may be virtual reference stations. The device may be configured to transmit satellite signal measurements associated with the second reference station to the mobile device by transmitting satellite signal measurements associated with the second reference station to the mobile device whilst not transmitting satellite signal measurements associated with the first reference station to the mobile device.

The device may be configured to calculate integer ambiguities for a baseline between the first reference station and the second reference station by calculating a set of integer ambiguities for the double differenced satellite signal measurements associated with the first and second reference stations. The device being configured to adjusting satellite signal measurements associated with the second reference station by adjusting the set of integer ambiguities for the double differenced satellite signal measurements associated with the first and second reference stations.

According to an eighth aspect of the present invention there is provided a mobile device for calculating a position of the mobile device relative to a selected reference station of a plurality of reference stations, the mobile device comprising: a satellite receiver configured to receive location signals from a plurality of satellites; and a communications interface configured to receive satellite signal measurements associated with a selected one of the plurality of reference stations; wherein the mobile device is configured to: receive satellite signal measurements associated with a first reference station; receive location signals from a plurality of satellites; track a baseline between the mobile device and the first reference station using the satellite signal measurements associated with the first reference station and the location signals to provide the position of the mobile device relative to the first reference station; send a handover request, the handover request comprising the current position of the mobile device; initialise tracking of a baseline between the mobile device and the second reference station using predetermined integer ambiguities; receive satellite signal measurements associated with the second reference station; and track the baseline between the mobile device and the second reference station using the satellite signal measurements associated with the second reference station and the location signals to provide the position of the mobile device relative to the second reference station.

The device may be configured to: send a subscribe message, the subscribe message requesting transmission of satellite signal measurements; and receive a subscribe response message, the subscribe response message indicating that integer ambiguities for the satellite signal measurements are predetermined integer ambiguities. The predetermined integer ambiguities may be equal to zero. The device may be configured to: receive a handover message indicating that the integer ambiguities are predetermined integer ambiguities. The device may be configured to: receive a handover message indicating an identifier for the second reference station. The device may be configured to send handover request by sending a handover request when the baseline between the mobile device and the first reference station is at least equal to a maximum baseline length.

Sending a handover request may comprise sending a handover request in response to at least one handover condition being fulfilled. The at least one handover condition may comprise the baseline between the mobile device and the first reference station being at least equal to a maximum baseline length. The at least one handover condition may comprise a predetermined length of time has elapsed since a handover request was sent. The at least one handover condition may comprise the tracking of the baseline between the mobile device and current reference station exhibiting outliers in the calculated position of the mobile device. The at least one handover condition may comprise the tracking of the baseline between the mobile device and the current reference station causes the calculated position of the mobile device to fall below a predetermined quality level. The device may be configured to calculate integer ambiguities for the baseline between the mobile device and the first reference station using the satellite signal measurements associated with the first reference station and the location signals. The satellite signal measurements may comprise carrier-phase measurements of satellite signals. The first reference station and second reference station may be virtual reference stations. The handover request may comprise an identifier for the first reference station. The device may be configured to initialise tracking of a baseline between the mobile device and the second reference station by transforming the integer ambiguities for the baseline between the mobile device and the first reference station into integer ambiguities for the baseline between the mobile device and the second reference station using the predetermined integer ambiguities. The device may be configured to receive satellite signal measurements associated with the second reference station by receiving satellite signal measurements associated with the second reference station whilst not receiving satellite signal measurements associated with the first reference station. The predetermined integer ambiguities may be a set of integer ambiguities for the double differenced satellite signal measurements associated with the first and second reference stations. The device may be configured to send, prior to receiving satellite signal measurements associated with the first reference station, a measurement stream request comprising the current position of the mobile device. The satellite signal measurements may be computed satellite signal measurements based on measurements by a plurality of physical reference stations.

The present invention will now be described by way of example with reference to the accompanying drawings. In the drawings:

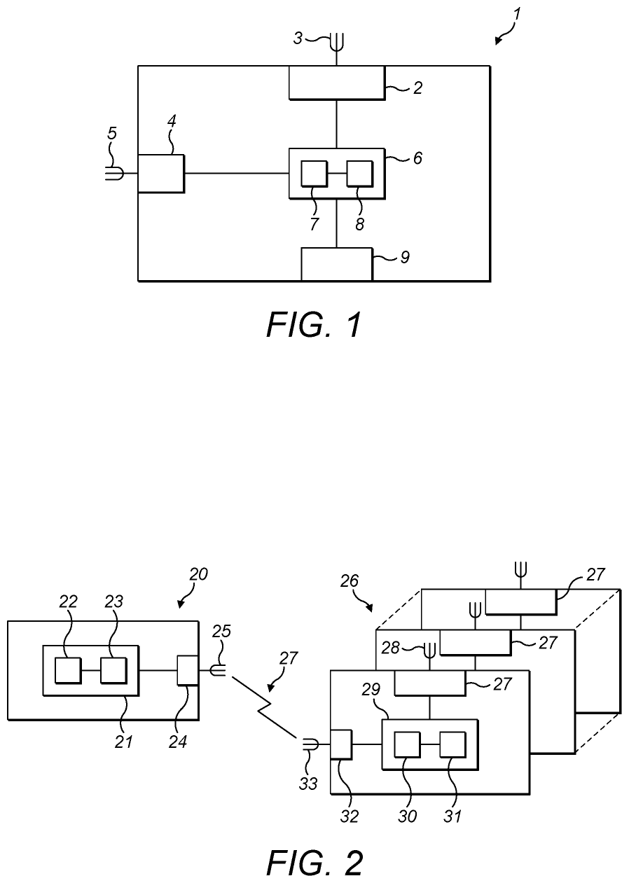

FIG. 1 shows a schematic diagram of a mobile device.

FIG. 2 shows a schematic diagram of a positioning server and a plurality of reference stations.

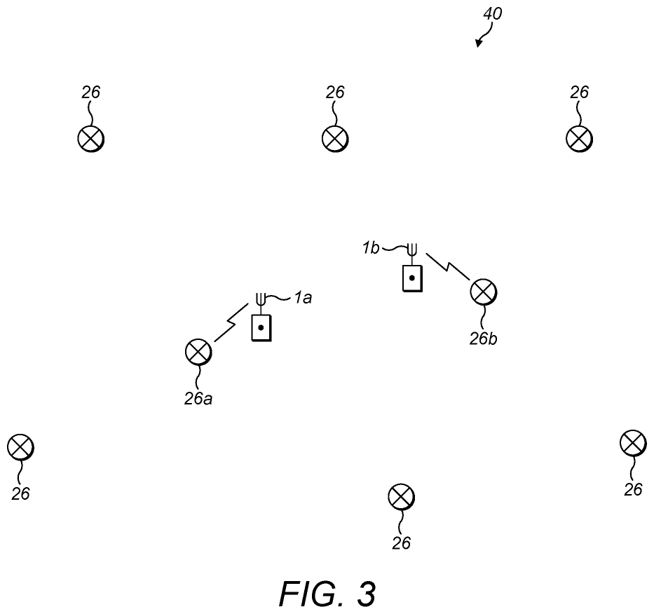

FIG. 3 shows an illustrative diagram of the placement of reference stations relative to a mobile device.

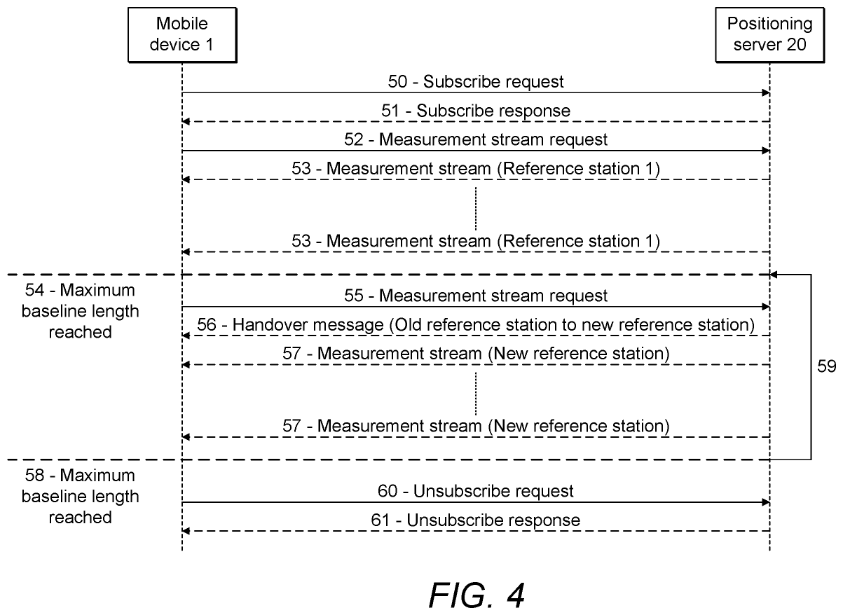

FIG. 4 shows a message sequence chart showing a mobile device requesting handover from one reference station to another reference station.

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The present invention relates to methods and devices for calculating a position of a mobile device relative to a selected reference station of a plurality of reference stations. The present invention also relates to methods and devices for providing satellite signal measurements to enable calculation of a position of a mobile device relative to a selected reference station of a plurality of reference stations.

FIG. 1 shows a mobile device 1. The mobile device 1 may be referred to as a rover. The mobile device 1 comprises a GNSS receiver 2. The GNSS receiver 2 is configured to receive location signals from a plurality of satellites. Those satellites may be part of one or more global navigation satellites systems. The GNSS receiver 2 may be coupled to one or more antennas 3 for the reception of the GNSS location signals. The GNSS receiver can use known techniques to receive and process the location signals. For example, the GNSS receiver may correlate PRN codes against the location signals to calculate pseudoranges to the satellites that send the location signals. The GNSS receiver may also calculate the phase of the carrier signals and/or code signals as received by the GNSS receiver.

The mobile device 1 also comprises a communication interface 4. The communication interface 4 may be a wireless communication interface. Alternatively, the communication interface 4 may be a wired communication interface that connects the mobile device to another device. That other device may have a wireless communication interface to enable wireless signals to be received and transmitted. Thus, the mobile device 1 on its own may be capable of receiving wireless communications or may be capable of receiving wireless communication via the other device. As shown in FIG. 1, the communication interface 4 may be coupled to one or more antennas 5 to send and/or receive wireless communications. In particular, communication interface 4 is configured to receive satellite signal measurements associated with one or more reference stations.

The mobile device 1 also comprises a processing section 6. The processing section may comprise a processor 7 and a memory 8. The memory 8 may be a non-volatile memory. The mobile device 1 may comprise more than one processor 7 and more than one memory 8. The memory 8 stores a set of program instructions that are executable by the processor, and reference data such as look-up tables that can be referenced by the processor in response to those instructions. The processor 7 may be configured to operate in accordance with a computer program stored in non-transitory form on a machine-readable storage medium. The computer program may store instructions for causing the processor to perform the operations of the mobile device 1 and methods associated with the mobile device as described herein. The processing section may comprise, in addition or instead of processor 7, dedicated hardware for implementing the methods described herein and thus comprise one or more integrated circuit chips.

The mobile device 1 may further comprise a user interface for configuring the mobile device and for displaying information regarding the mobile device 1. The user interface may be a graphical user interface that may be interacted with by a user using a touch screen and/or dedicated controls. The user interface may function as a screen to display information such as navigation information.

The mobile device 1 may be a discrete device. The mobile device 1 may be part of another object and provide location information to the object. The object may process the location information for its own purposes. For instance, the mobile device may be part of a vehicle and provides location information to the vehicle.

As discussed above, the communication interface 4 is configured to receive satellite signal measurements associated with one or more reference stations. The communication interface 4 may receive those satellite signal measurements from a positioning server 20 as shown in FIG. 2.

Positioning server device 20 comprises a processing section 21. Processing section 21 may comprise a processor 22 and a memory 23. The processing section 21, processor 22, and memory 23 may be configured in the manner described with relation to the processing section 6 of mobile device 1 to operate in accordance with the methods and manner of the positioning server 20 as described herein. The processing section 21 is connected to a communication interface 24. Communication interface 24 may have one or more antennas 25 if the communication interface 23 is a wireless communication interface. Alternatively, communication interface 24 may be connected to a network or other devices to enable communication 27 by the server 20 with a plurality of reference stations 26. The positioning server device 20 can communicate with the mobile device 1 using communication interface 24.

The reference stations 26 are distributed over a location area. The reference stations 26 are each configured to receive location signals from a plurality of GNSS satellites. The reference stations 26 each have a GNSS receiver 27. The GNSS receiver 27 is configured to receive location signals from a plurality of satellites. Those satellites may be part of one or more global navigation satellites systems. The GNSS receiver 27 may be coupled to one or more antennas 28 for the reception of the GNSS location signals. The GNSS receiver can use known techniques to receive and process the location signals. For example, the GNSS receiver may correlate PRN codes against the location signals to calculate pseudoranges to the satellites that send the location signals. The GNSS receiver may also calculate the phase of the carrier signals and/or code signals as received by the GNSS receiver.

The reference stations 26 each comprise a processing section 29. Processing section 29 may comprise a processor 30 and a memory 31. The processing section 29, processor 30, and memory 31 may be configured in the manner described with relation to the processing section 6 of mobile device 1 to operate in accordance with the methods and manner of the reference station 20 as described herein. The processing section 29 is connected to a communication interface 32. Communication interface 32 may have one or more antennas 33 if the communication interface 32 is a wireless communication interface. Alternatively, communication interface 32 may be connected to a network or other devices to enable communication 27 by the reference stations 26 with the positioning server 20.

The processing section 29 can receive location information from the GNSS receiver. For instance, it can receive satellite signal measurements from the GNSS receiver. Those satellite signal measurements may be carrier and/or code phase measurements. Alternatively, the processing section 29 may receive information concerning the location signals received by the GNSS receiver and the processing section 29 may analyse those location signals to calculate satellite signal measurements. The reference station 26 is configured to send those measurements to server 20 using communication interface 32.

The server 20 may communicate with mobile device 1 to send satellite signal measurements to the mobile device 1. The satellite signal measurements that are sent to the mobile device 1 may be associated with the physical reference stations 26. Alternatively, the server 20 may compute satellite signal measurements for a plurality of virtual reference stations based on the actual satellite signal measurements received from physical reference stations 26. The computed satellite signal measurements approximately replicates measurements which could be expected from a receiver at the location of the virtual reference station. This may be done because the physical reference stations 26 may be spaced at distances that means the baseline between a reference station 26 and a mobile device 1 may be too long to be useful for accurately calculating the mobile device's position. The methods by which a server may compute satellite signal measurements for virtual reference stations in generally known in the art. The position of the reference stations, whether virtual or physical or a combination of the two, may be selected so that there is coverage of the location area such that a mobile device is within useful distance of at least one reference station for calculating the base line between the mobile device and the reference station.

FIG. 3 shows the reference stations 26 positioned within a location area 40. As detailed herein, those reference stations 26 may be physical reference stations that receive the location signals themselves, virtual reference stations that have satellite measurement streams generated by the positioning server 20, or a combination of the two. The virtual reference stations may be in fixed positions within the location area. Thus, the reference stations may be in fixed positions within the location area. FIG. 3 also shows two positions 1a and 1b for mobile device 1. In position 1a, mobile device 1 is closer to reference station 26a. In position 1b, mobile device 1 is closer to reference station 26b. Thus, ideally mobile device 1 would compute its position based on satellite signal measurements that are associated with base station 26a when in position 1a and would compute its position based on satellite signal measurements that are associated with reference station 26b when in position 1b.

It is assumed that at a point between reference station 26a and 26b the baseline between mobile device 1 and reference station 26a reaches a distance that equal to the maximum baseline distance. Therefore, at this point, assuming that the baseline between mobile device 1 and reference station 26b is less than the maximum base line distance, the mobile device 1 should ideally be calculating its position based on satellite signal measurements associated with reference station 26b. Thus, the mobile device 1 may decide to send a handover request based on the baseline length between the mobile device and the current reference station.

There may be other considerations rather than the maximum baseline distance that the mobile device 1 takes into account when deciding to request a handover from one reference station to another. The mobile device 1 may detect outliers in the current position calculation. This generally indicates that there are errors present in the current position calculation that are not being removed by the double differencing technique. Therefore, the mobile device 1 may request a handover to a different reference station in the hope that the new measurement stream cancels the errors more completely and thus results in a better position calculation. The mobile device 1 may request handover to a new reference station after a predetermined time period after the last handover occurred. The mobile device 1 may use the predetermined time period to avoid switching between reference stations frequently when operating at or near the maximum baseline length for multiple reference stations. The mobile device 1 may detect the reference station service provider and decide to request a handover when entering the coverage area of a reference station with a different service provider.

Thus, the mobile device 1 may decide to send a handover request to the server based on at least one handover condition. Thus, the mobile device 1 may send the handover request when at least one handover condition is fulfilled. The handover condition(s) may comprise:
The baseline between the mobile device and a current reference station being at least equal to a maximum baseline length.
A predetermined length of time has elapsed since a handover request was sent by the mobile device 1.
The tracking of the baseline between the mobile device 1 and current reference station exhibits outliers in the calculated position of the mobile device 1.
The tracking of the baseline between the mobile device 1 and the current reference station causes the calculated position of the mobile device to fall below a predetermined quality level.
The current position of the mobile device 1 indicates that the mobile device 1 has entered a new service provider region.

To enable the handover from one reference station to another without the need to receive satellite signal measurements associated with two reference stations at the same time, the mobile device 1 is provided with information required to calculate the initialization parameters without the need to solve the initialization problem from scratch. This is advantageous because it means the mobile device 1 only needs to receive satellite signal measurements associated with one reference station at a time. The mobile device 1 can switch from receiving satellite signal measurements associated with a first reference station 26a to receiving satellite signal measurements associated with a second reference station 26b without an overlap in the reception of the two measurement streams.

This is achieved by the positions of the reference stations, whether physical and/or virtual, being predetermined. This means that the positioning server 20 can calculate the baseline and integer ambiguities between each of the two reference stations. The positioning server 20 may be configured to calculate baselines and integer ambiguities between only those reference stations that it is likely the mobile device 1 will handover between. E.g. those reference stations that surround another reference station. Thus, with the baseline and the integer ambiguities between two reference stations being known to the positioning server 20, those details can be transmitted to the mobile device to enable the mobile device to calculate the new baseline and integer ambiguities between the mobile device and the new reference station. The mobile device can use the baseline and integer ambiguities between the present reference station and the new reference station to calculate the baseline and integer ambiguities between the mobile device and the new reference station in the following way.

In a double difference carrier phase navigation system, an integer ambiguity and baseline is required for each difference between a reference satellite and each of the other satellites being used. Taking the mobile device 1 to be a rover device r, the first reference station 26a to be reference station k, the second reference station 26b to be reference station m, the new baseline and integer ambiguity for satellites l and q can be calculated using the following equations:

$${N}_{rm}^{lq} = [ \begin{matrix}1 & 0 \\ 0 & 1\end{matrix} ] [ \begin{matrix}{N}_{rk}^{lq} \\ {N}_{km}^{lq}\end{matrix} ]$$

$${ρ}_{rm}^{lq} = [ \begin{matrix}1 & 0 \\ 0 & 1\end{matrix} ] [ \begin{matrix}{ρ}_{rk}^{lq} \\ {ρ}_{km}^{lq}\end{matrix} ]$$

Where Nᵣₘ^{lq} is the integer ambiguity between rover r and reference station m associated with satellites l and q and ρᵣₘ^{lq} is the baseline between rover r and reference station m associated with satellites l and q. The calculation for the other integer ambiguities and baselines follow the same notation scheme and formulae. The integer ambiguities and baselines can be calculated for the other satellites being used in the same way. Thus, the previous solution between the mobile device r and the reference station k can be automatically updated to the solution between the mobile device r and the reference station m. There is no need to estimate any states for the baseline between the mobile device 1 and the new reference station 26b through observation and therefore consider measurement noise. The mobile device 1 can thus update its baselines and integer ambiguities for the baseline tracking between its position and the new reference station 26b.

The double difference integer ambiguity values assume a reference satellite which is common throughout the double differences. If the mobile device 1 selects a different reference satellite than that selected by the positioning server 20 in the reference network, then the mobile device 1 can convert those ambiguity values into values having the reference satellite that the mobile device 1 has used. This conversion makes use of the point that the double difference between all satellites and the reference satellite are known and so the N values for differences between any satellite pair can be calculated. The following equation shows the case for calculating the integer ambiguity for satellites a and c using the integer ambiguity for satellites b and c where satellite b is being used as the reference satellite.

Nᵣₘ^{ac}=Nᵣₘ^{ab}+Nᵣₘ^{bc}

Thus, the mobile device can calculate the set of integer ambiguities that are required for its choice of reference satellite.

The server can therefore send to the mobile device a set of double difference integer ambiguities between the current reference station and new reference station for between each of the server selected reference satellite and each of the other satellites. This set of double difference integer ambiguities could be formatted as a vector. The mobile device can then use this information to calculate the integer ambiguities for the baseline tracking between the mobile device and the new reference station and thus switch instantly to using the measurement stream from the new reference station.

The server may be configured to adjust the satellite signal measurements associated with the reference stations so that the integer ambiguities between each pair of reference stations is set to predetermined integer ambiguities. The satellite signal measurements may be adjusted so that the integer ambiguities between each pair of reference station is set to zero. In either case, this has the advantage of meaning that the mobile device 1 can initialise the baseline tracking to the new reference station without needing extra information about the integer ambiguities. Either they are zero or the mobile device 1 can be provided with the predetermined integer ambiguities once (potentially once per connection) and store them in memory for use with each transition to a new reference station. Thus the integer ambiguities vector estimated at the mobile device 1 is unchanged when a reference station handover occurs.

This approach means that the server needs to select a zero point in the system for the reference station measurement signals and then apply corrections to the measured cycle count of the other reference stations to make the resulting integer ambiguities equal to predetermined integer ambiguities (which could be zero). In the below example measurements from reference station m are being synchronized with reference station k for satellite pair l and q.

Øₖₘ^{lq}=(Øₖ^{l}−Øₘ^{l})−(Øₖ^{q}−Øₘ^{q})

Øₖₘ^{lq}=ρₖₘ^{lq}+λNₖₘ^{lq}+εₖₘ^{lq}

Øₘ_{₀}^{l}=Øₘ^{l}+λNₖₘ^{lq}

Øₖₘ_{₀}^{lq}=(Øₖ^{l}−Øₘ_{₀}^{l})−(Øₖ^{q}−Øₘ^{q})

Øₖₘ_{₀}^{lq}=ρₖₘ^{lq}+εₖₘ^{lq}

Where Ø is the carrier phase measurement with unknown integer ambiguity, ρ is the pseudo-range, λ is the wavelength, N is the integer ambiguity and ε is the measurement noise. This is given as an example only and it will be apparent that other methods may be used to adjust the satellite signal measurements.

The satellite signal measurements associated with a second reference station can therefore be adjusted using integer ambiguities that have been calculated for a baseline between a first reference station and a second reference station. The satellite signal measurements associated with reference stations other than the first reference station may be adjusted in a similar manner. The satellite signal measurements associated with the second reference station can be adjusted by subtracting respective calculated integer ambiguities for the baseline between the first reference station and the second reference station from the satellite signal measurements associated with the respective integer ambiguities.

The handover of the mobile device from using a first reference station to a second reference station when the mobile device judges that it needs to move to a new reference station, for instance because the baseline between the mobile device and the first reference station is at least equal to a maximum baseline will now be explained with reference to FIG. 4.

As shown at 50, the mobile device 1 requests being permitted to subscribe to the measurement streams by sending a subscribe request 50 to the positioning server 20. This request may be made when the mobile device 1 wants to calculate its position using baseline tracking relative to one of the reference stations under control of the positioning server 20 at a time. The subscribe request 50 may comprise a set of information regarding the mobile device and its request to use the reference station network. For instance, the subscribe request may comprise:
A mobile device ID that identifies the mobile device 1 to the positioning server 20.
A password or other authentication passphrase that can be used by the positioning server 20 to decide that the mobile device with a particular mobile device ID has permission to access the reference station network.
Device capability information, such as which satellite constellations the device can use, which frequencies the device can use, the reception ability of the device to receive the measurement streams (e.g. so that the device does not go out of reception range).
Device movement direction information. This can be used by the positioning server 20 to decide which reference station it would be best to select as an initial reference station for providing the measurement stream.
Device waypoint information. This can be used by the positioning server 20 to decide which reference station it would be best to select as an initial reference station and may also be used by the positioning server 20 future reference stations it would be best to select.

As shown at 51, the positioning server 20 can respond with a subscribe response 51. The subscribe response 51 can indicate whether or not the subscribe request has been successful. In the case, that the server 20 is providing adjusted measurement streams, the subscribe response 51 may indicate the predetermined integer ambiguities and/or that those predetermined integer ambiguities are zero.

If the subscribe response 51 is a subscribe success message, then the mobile device can request a measurement stream as shown at 52. The measurement stream request 52 may include device location information which indicates the current location of the device. This location may be generated using the rough position calculations that can be derived from location signals provided by satellites or via other methods such as by identification of a base station that the device is communicating with. The measurement stream request 52 may also include details of the current reference station that the mobile device 1 is currently receiving a measurement stream that is associated with that current base station. In the case of the initial measurement stream request 52 to the positioning server 20, no information about a current reference station can be sent.

In response to the measurement stream request 52, the positioning server 20 selects a measurement stream associated with a reference station based on the position of the mobile device 1. The closest reference station to the mobile device 1 may be chosen. Alternatively, as discussed herein, another reference station may be chosen based on the current direction of transit of the mobile device 1 which may mean the mobile device 1 can use the measurement stream associated with that other reference station for a longer period of time.

Once the reference station has been selected, the measurement stream associated with that reference station is streamed to the mobile device 1. This is as shown at 53. The measurement stream is associated with a first reference station. The mobile device 1 can calculates integer ambiguities for the baseline between the mobile device 1 and the first reference station using the satellite signal measurements comprised in the measurement stream 52 and location signals received directly by the mobile device 1. This initialises the mobile device's positioning calculations using the measurement stream and location signals so that it can track the baseline between the mobile device 1 and the first reference station. The mobile device 1 can use any standard method for initialising the position calculation and for tracking the baseline between the mobile device 1 and the first reference station. The mobile device 1 may perform relative positioning computations using double difference observables. These double difference observables are formed from the satellite signal measurements associated with the first reference station and satellite signal measurements made by the mobile device 1 on the location signals received directly by the mobile device. The double difference observables may be formed from carrier phase measurements comprised in the measurement stream and carrier phase measurements made on the location signals received from satellites by the GNSS receiver 2 of the mobile device 1. The mobile device 1 may use the Real-Time Kinematic navigation technique to calculate the baseline between the mobile device 1 and the reference stations or any other suitable differencing technique to generate the baseline.

Once the mobile station 1 has resolved the integer ambiguities associated with the baseline between the mobile station 1 and the first reference station, the mobile station can track the baseline between the mobile device and the first reference station using the measurement stream associated with the first reference station and the location signals received by the GNSS receiver 2.

As discussed herein, the measurement stream 53 may be an adjusted measurement stream so that the integer ambiguities are equal to predetermined integer ambiguities. In this case the initialisation process due to handover may be significantly shortened because the mobile device 1 does not need to calculate the integer ambiguities.

The positioning server 20 continues to stream the measurement stream 53 to the mobile device 1 until the mobile device 1 requests the positioning server 20 to stop, until the mobile device 1 loses its connection to the positioning server 20, or until the mobile device 1 judges that it needs to switch to a new reference station, for instance because the baseline between mobile device 1 and the first reference station is at least equal to a maximum baseline length. The maximum baseline length may be selected as the distance from the reference station position where the errors associated with the baseline calculation no longer sufficiently cancel. This can be because the assumptions surrounding the cancellation of those errors now no longer sufficiently applies. A different maximum baseline length may be selected for different reference stations. This may occur because the atmospheric conditions are known to be different in specific areas or there may be less reference stations present in a particular area.

The mobile device 1 may monitor the baseline between the mobile device and the reference station and determine when the maximum baseline length has been reached. The maximum baseline length may be transmitted to the mobile device 1 by the positioning server 20. The maximum baseline length may be calculated by the mobile device 1.

In the example shown at 54, the baseline between the mobile device 1 and the first reference station is at least equal to the maximum baseline length although it could be another determination instead or as well as. At this point, the mobile device 1 sends a measurement stream request 55 to the positioning server 20. This measurement stream request 55 may be a handover request. The handover request is requesting that the mobile device 1 be sent a new measurement stream associated with a reference station that is more suitable for the mobile device 1 based on the mobile device's current position. The measurement stream request 55 can include both the mobile device's current position and also the current reference station that is associated with the measurement stream that the mobile device is currently receiving.

The positioning server 20 can use the details contained in the handover request 55 to select a new reference station for the mobile device. The positioning server 20 can also provide the details required to enable the mobile device 1 to start tracking the baseline between the mobile device and the new reference station without needing to undergo the initialisation procedure that calculates the integer ambiguities for the new baseline. The positioning server 20 selects the new reference station based on the position of the mobile device 1 as communicated to it in the handover request. The positioning server 20 may select the reference station which has a position closest to the mobile device 1. The handover request 55 may also include information about the current transit direction of the mobile device 1 and so the positioning server 20 may select the reference station dependent on the transit information so that the mobile device 1 can use the new reference station for as long as possible.

The positioning server 20 may also have calculated the integer ambiguities associated with the baseline between the first reference station and the new, second reference station. This uses the satellite signal measurements associated with both the first and second reference stations. As described herein, the positioning server 20 may have calculated these integer ambiguities in advance so that they are available to be sent to the mobile device 1 as required. The integer ambiguities may need to be updated when the constellation of satellites changes. Alternatively, the server 20 may have set the integer ambiguities to be equal to predetermined integer ambiguities.

Thus, as shown in 56, the positioning server sends a handover message 56 to the mobile device 1. The handover message may comprise the integer ambiguities for the baseline between the first reference station and the second reference station. It may indicate that the integer ambiguities have been set to the predetermined integer ambiguities. It may supply those predetermined integer ambiguities and/or indicate that they are zero.

The integer ambiguities may be formatted as a handover vector which comprises each of the integer ambiguities associated with the baseline between the first reference station and the second reference station. The handover vector may comprise integer ambiguities for each satellite that is part of the measurement stream of both the first reference station and second reference station. The handover message may also include the position of the second reference station. The handover message may include the baseline between the first and second reference stations.

The integer ambiguities may each be for a reference satellite signal that has been differenced with a respective one of the other satellites contained in the measurement stream of both the first and second reference stations. The integer ambiguities may be for each differenced satellite signal as part of the measurement streams associated with the first and second reference stations. I.e. the satellite signal associated with the first reference stream is differenced with the satellite signal associated with the second reference steam and then those differenced satellite signals are differenced with a reference satellite signal to form the double differenced signals.

The mobile device 1 can initialise the tracking of a baseline between the mobile device and the second reference station using the integer ambiguities contained in the handover message. Alternatively, if the integer ambiguities have been set to predetermined values then the mobile device 1 may already have stored those values, or know that they are set to zero.

The mobile device 1 can use this set of integer ambiguities to transform the set of integer ambiguities associated with the baseline between the mobile device and the first reference station into a set of integer ambiguities associated with the baseline between the mobile device and the second reference station. This is as described herein and avoids the need to calculate the integer ambiguities associated with the baseline between the mobile device and the second reference station from scratch. Therefore, the mobile device 1 can switch directly to tracking the baseline between the mobile device and second reference station when the positioning server 20 switches from transmitting the measurement stream associated with the first reference station to transmitting the measurement stream associated with the second reference station. Thus, the mobile device 1 only receives the measurement stream associated with one reference station at a time.

As shown by 57, the positioning server 20 switches to transmitting the measurement stream 57 associated with the second reference station and at the same time stops transmitting the measurement stream 53 associated with the first reference station. The positioning server 20 only transmits one measurement stream to the mobile device 1 at a time.

As shown at 58 and 59, if the mobile device 1 detects that the baseline between the mobile device 1 and the second reference station is at least equal to the maximum baseline length, then the mobile device 1 can generate another handover request and start the process of moving to a new reference station again. As described herein, the mobile device may use other determinations to generate another handover request. This is as shown by arrow 59 returning to the mobile device 1 sending a measurement stream request 55.

As shown at 60, when the mobile device 1 no longer needs the accurate positioning provided by the measurement streams, the mobile device 1 can send an unsubscribe request 60 to the positioning server 20. The unsubscribe request 60 may include at least some of the information that was contained in the subscribe request 50. For instance, the unsubscribe request 60 may include the mobile device ID. The unsubscribe request 60 may also include the password or other authentication passphrase associated with the mobile device.

In response, the server may send an unsubscribe response 61 indicating whether the unsubscribe request has been successful.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A method for calculating a position of a mobile device relative to a selected reference station of a plurality of reference stations, the method comprising:
receiving satellite signal measurements associated with a first reference station;
receiving location signals from a plurality of satellites;
tracking a baseline between the mobile device and the first reference station using the satellite signal measurements associated with the first reference station and the location signals to provide the position of the mobile device relative to the first reference station;
sending a handover request, the handover request comprising a current position of the mobile device;
receiving a handover message comprising integer ambiguities for a baseline between the first reference station and a second reference station;
initialising tracking of a baseline between the mobile device and the second reference station using the integer ambiguities of the handover message;
receiving satellite signal measurements associated with the second reference station; and
tracking the baseline between the mobile device and the second reference station using the satellite signal measurements associated with the second reference station and the location signals to provide the position of the mobile device relative to the second reference station.

2. The method according to claim 1, wherein sending a handover request comprises sending a handover request when the baseline between the mobile device and the first reference station is at least equal to a maximum baseline length.

3. The method according to claim 1, wherein sending a handover request comprises sending a handover request in response to at least one handover condition being fulfilled.

4. The method according to claim 3, wherein the at least one handover condition comprises at least one of:
the baseline between the mobile device and the first reference station being at least equal to a maximum baseline length;
a predetermined length of time having elapsed since a handover request was sent;
the tracking of the baseline between the mobile device and the first reference station exhibiting outliers in the calculated position of the mobile device; and
the tracking of the baseline between the mobile device and the first reference station causes the calculated position of the mobile device to fall below a predetermined quality level.

5.-7. (canceled)

8. The method according to claim 1, the method comprising calculating integer ambiguities for the baseline between the mobile device and the first reference station using the satellite signal measurements associated with the first reference station and the location signals.

9. The method according to claim 1, wherein the satellite signal measurements comprise carrier-phase measurements of satellite signals.

10. The method according to claim 1, wherein the first reference station and second reference station are virtual reference stations.

11. The method according to claim 1, wherein the handover request comprises an identifier for the first reference station.

12. The method according to claim 1, wherein the handover message comprises a handover vector that comprises the integer ambiguities for the baseline between the first reference station and the second reference station.

13. The method according to claim 1, wherein initialising tracking of a baseline between the mobile device and the second reference station comprises transforming the integer ambiguities for the baseline between the mobile device and the first reference station into integer ambiguities for the baseline between the mobile device and the second reference station using the integer ambiguities of the handover message.

14. The method according to claim 1, wherein receiving satellite signal measurements associated with the second reference station comprises receiving satellite signal measurements associated with the second reference station whilst not receiving satellite signal measurements associated with the first reference station.

15. The method according to claim 1, wherein the integer ambiguities of the handover message are a set of integer ambiguities for double differenced satellite signal measurements associated with the first and second reference stations.

16. The method according to claim 1, the method comprising sending, prior to receiving satellite signal measurements associated with the first reference station, a measurement stream request comprising the current position of the mobile device.

17. The method according to claim 1, wherein the satellite signal measurements are computed satellite signal measurements based on measurements by a plurality of physical reference stations.

18. A method for providing satellite signal measurements to enable calculation of a position of a mobile device relative to a selected reference station of a plurality of reference stations, the method comprising:
transmitting satellite signal measurements associated with a first reference station to a mobile device;
receiving a handover request comprising a current position of the mobile device;
selecting a second reference station based on the current position of the mobile device;
calculating integer ambiguities for a baseline between the first reference station and the second reference station using satellite signal measurements associated with the first reference station and satellite signal measurements associated with the second reference station;
transmitting a handover message comprising the integer ambiguities for the baseline between the first reference station and the second reference station; and
transmitting satellite signal measurements associated with the second reference station to the mobile device.

19. The method according to claim 18, wherein selecting a second reference station comprises selecting the reference station that has a position closest to the current position of the mobile device.

20. The method according to claim 18, wherein the handover message comprises a handover vector that comprises the integer ambiguities for the baseline between the first reference station and the second reference station.

21. The method according to claim 18, the method comprising calculating the satellite signal measurements associated with the first reference station based on satellite signal measurements received by a plurality of physical reference stations; and calculating the satellite signal measurements associated with the second reference station based on satellite signal measurements received by a plurality of physical reference stations.

22. (canceled)

23. The method according to claim 18, wherein the satellite signal measurements comprise carrier-phase measurements of satellite signals.

24. The method according to claim 18, wherein the first reference station and second reference station are virtual reference stations.

25. The method according to claim 18, wherein transmitting satellite signal measurements associated with the second reference station to the mobile device comprises transmitting satellite signal measurements associated with the second reference station to the mobile device whilst not transmitting satellite signal measurements associated with the first reference station to the mobile device.

26. The method according to claim 18, wherein calculating integer ambiguities for a baseline between the first reference station and the second reference station comprises calculating a set of integer ambiguities for double differenced satellite signal measurements associated with the first and second reference stations.

27. A mobile device for calculating a position of the mobile device relative to a selected reference station of a plurality of reference stations, the mobile device comprising: a satellite receiver configured to receive location signals from a plurality of satellites; and a communications interface configured to receive satellite signal measurements associated with a selected one of the plurality of reference stations; wherein the mobile device is configured to:
receive satellite signal measurements, using the communications interface, associated with a first reference station;
receive location signals, using the satellite receiver, from a plurality of satellites;
track a baseline between the mobile device and the first reference station using the satellite signal measurements associated with the first reference station and the location signals to provide the position of the mobile device relative to the first reference station;
send a handover request, the handover request comprising a current position of the mobile device;
receive a handover message comprising integer ambiguities for a baseline between the first reference station and a second reference station;
initialise tracking of a baseline between the mobile device and the second reference station using the integer ambiguities of the handover message;
receive satellite signal measurements, using the communication interface, associated with the second reference station; and
track the baseline between the mobile device and the second reference station using the satellite signal measurements associated with the second reference station and the location signals to provide the position of the mobile device relative to the second reference station.

28.-43. (canceled)

44. A positioning server device for providing satellite signal measurements to enable calculation of a position of a mobile device relative to a selected reference station of a plurality of reference stations, the device comprising at least one communication interface, the device being configured to communicate with a plurality of physical reference stations using at least one of the communication interfaces and communicate with the mobile device using at least one of the communication interfaces; the device being configured to:
transmit satellite signal measurements associated with a first reference station to a mobile device;
receive a handover request comprising a current position of the mobile device;
select a second reference station based on the current position of the mobile device;
calculate integer ambiguities for a baseline between the first reference station and the second reference station using satellite signal measurements associated with the first reference station and satellite signal measurements associated with the second reference station;
transmit a handover message comprising the integer ambiguities for the baseline between the first reference station and the second reference station; and
transmit satellite signal measurements associated with the second reference station to the mobile device.

45.-125. (canceled)
